(19) United States
(12) Patent Application Publication
(10) Pub. No.: US 2017/0362887 A1
(43) Pub. Date: Dec. 21, 2017

(54) SLAT CONTROL MECHANISM FOR BLINDS

(71) Applicant: Whole Space Industries LTD, Taipei (TW)

(72) Inventor: Tzu-Yen Lin, Taipei (TW)

(21) Appl. No.: 15/185,400

(22) Filed: Jun. 17, 2016

(51) Int. Cl. E06B 9/322; E06B 9/307; E06B 9/382

(52) U.S. Cl. CPC E06B 9/322; E06B 9/382; E06B 9/307; E06B 2009/3222

(57) ABSTRACT

A window covering includes a first cord extending along a drive pulley of a first ladder control mechanism such that motion of the lift cord along the drive pulley during retraction of slats towards a first rail drives rotation of the drive pulley in a first rotational direction to rotate a ladder pulley for tilting of the slats from an open position to a closed position and motion of the lift cord along the drive pulley during extension of the slats drives rotation of the drive pulley in a second rotational direction to rotate the ladder pulley for tilting of the slats from the closed position to the open position. The ladder may be composed of cord or tape. Each ladder may include a front rail, a rear rail, and rungs that extend between the front and rear rails for supporting the slats.

### FIELD OF INVENTION

The present innovation relates to window coverings such as blinds, a control mechanism for adjusting the position of slats, and methods of making and using the same.

### BACKGROUND OF THE INVENTION

Window coverings can be configured so that a material is moveable to partially or fully cover a window. Examples of window coverings can be appreciated from U.S. Pat. Nos. 9,181,751, 9,091,115, 9,078,537, 8,939,190, 8,708,023, 8,281,843, 8,251,120, 8,087,445, 8,079,398, 8,002,012, 7,984,745, 7,950,437, 7,866,367, 7,721,783, 7,654,301, 7,664,748, 7,624,785, 7,503,370, 7,398,815, 7,311,133, 7,287,569, 7,228,797, 7,219,710, 7,178,577, 7,168,476, 7,159,636, 7,143,802, 7,117,919, 7,093,644, 7,025,107, 6,978,822, 6,761,203, 6,644,373, 6,644,372, 6,601,635, 6,571,853, 6,283,192, 6,129,131, 5,699,847, 5,582,226, 5,482,100, 3,129,750, 2,420.301, and 13,251 and U.S. Pat. App. Pub. Nos. 2013/0126105, 2013/0048233, 2013/0075045, 2012/0211180, 2013/0091968, 2012/0305199, 2013/0248125, 2011/0024065, 2012/20227910, 2011/0198044, 2012/0160426, 2012/0175067, 2011/0247761, 2010/0126673 and 2010/0126678.

Spring motors that may be employed in window covering to permit the window covering to have its height controlled without the use of an exposed operator cord. But, such spring motors are often unable to effect any adjustment of slats that may be supported by ladders that extend from a headrail to support spaced apart slats. Instead, a wand or operator tilt cord may be required to be manipulated by a user to effect a tilting of slats for closing or opening the slates while the blind is extended or at least partially extended. Examples of slat control systems can be appreciated from U.S. Pat. Nos. 5,472,035 and 5,165,459 and U.S. Pat. App. Pub. Nos. 2013/0306253, 2005/0022947 and 2003/0221799. I have determined that a new mechanism is needed to permit a user to more easily effect a tilting of slats when using a window covering such as a venetian blind (which is also referred to as a mini blind).

### SUMMARY OF THE INVENTION

Embodiments of a window covering are provided herein. The window covering can be configured as a venetian blind or a mini blind in some embodiments. The window covering can include a slat control mechanism. In some embodiments, the slat control mechanism can be integrated into the height adjustment mechanism of the window covering to permit the tilting of the slats to occur while a user is providing a force for adjusting the height of the window covering. For instance, the slat control mechanism can include a plurality of ladder control mechanisms that are integrated into the height adjustment mechanism of the window covering for some embodiments. Such embodiments may permit slat tilting to be actuated by a user without the use of a tilt wand or tilt control cord extending from the headrail of a blind. Methods of making and using the window covering and slat control mechanism are also provided herein.

In some embodiments, a window covering is provided that includes a first rail, a spring motor unit positioned in the first rail, a first lift cord connected to the spring motor unit, a first ladder control mechanism having a drive pulley connected to a ladder pulley such that rotation of the drive pulley in a first rotational direction drives rotation of the ladder pulley and rotation of the drive pulley in a second rotational direction also drives rotation of the ladder pulley, the first rotational direction being opposite the second rotational direction, and a first ladder supporting a plurality of slats. The first ladder can be connected to the ladder pulley of the first ladder control mechanism. The plurality of slats can be moveable relative to the first rail so that the slats are moveable between an extended position and a retracted position. The first lift cord can extend along the drive pulley of the first ladder control mechanism such that motion of the first lift cord along the drive pulley during one of retraction and extension of the slats drives rotation of the drive pulley in the first rotational direction to rotate the ladder pulley for tilting of the slats from an open position to a closed position and motion of the lift cord along the drive pulley during the other of the retraction and the extension of the slats drives rotation of the drive pulley in the second rotational direction to rotate the ladder pulley for tilting of the slats from the closed position to the open position.

In some embodiments the window covering can be configured as a venetian blind or as a mini blind. The slats may have any of a number of different shapes and may be composed of any suitable material such as wood, polymeric material, metal, or a composite material.

The window covering can be configured as blind having just a headrail, a blind having a bottom rail and a headrail, or a top down bottom up shade. The first rail may be configured as a headrail, a bottom rail, or an intermediate rail (e.g. an intermediate rail or middle rail of a top down bottom up shade).

In some embodiments, the first ladder control mechanism can also include a friction pulley. The first lift cord can be routed to pass from the drive pulley to the friction pulley to pass along the friction pulley and be routed to also pass from the friction pulley to the drive pulley. For instance, the first lift cord may be so routed to forma first loop between the drive pulley and the friction pulley.

The first ladder control mechanism can also include a first gear connected to the drive pulley and a second gear connected to the ladder pulley. The first gear can have teeth that intermesh with teeth of the second gear such that rotation of the drive pulley drives rotation of the ladder pulley. In such embodiments, the first gear may be integrally connected to the drive pulley and the second gear may be integrally connected to the ladder pulley.

The first ladder control mechanism can also include a housing. The drive pulley and the ladder pulley can be connected to the housing such that a rotational axis about which the drive pulley is rotatable is perpendicular or substantially perpendicular to a rotational axis about which the ladder pulley is rotatable. The housing can be configured so that the ladder pulley can be located above the drive pulley when those pulleys are attached to the housing.

The spring motor unit can be configured to include one or more spring motors. In some embodiments, the spring motor unit can include a first spring motor pulley, a second spring motor pulley, and a spring member extending between the first and second spring motor pulleys. A first end of the spring member may be connected to the first spring motor pulley and the second end of the spring member may be connected to the second spring motor pulley so that those pulleys rotate in a first direction so that the spring member winds further upon one of the spring motor pulleys and unwinds from the other of the spring motor pulleys when the slats are extended and so that, to effect retraction of the slats, the spring member is biased to wind further upon the spring member that it unwinds from during the extension of the salts and is configured, to unwind from the spring member that it winds about during extension of the slats to drive retraction of the slats

The window covering can also include other pulleys. For instance, the window covering can include a first lift cord pulley connected to the first spring motor pulley. The first lift cord can be connected to the first lift cord pulley to be connected to the spring motor unit. The first lift cord can be windable about the first lift cord pulley during retraction of the slats and the first lift cord can be unwindable form the first lift cord pulley during extension of the slats.

The first ladder can be structured to include a front rail, a rear rail and spaced apart rungs extending between the front and rear rails. The front and rear rails can be segments of a cord or tape. Alternatively, the front and rear rails may be separate cord or tape that are connected together. In some embodiments, the first ladder may be structured as a ladder cord comprised of cord or tape.

A venetian blind is also provided. In some embodiments, the venetian blind can include a first rail, a plurality of slats that are moveable relative to the first rail between an extended position and a retracted position, a spring motor unit positioned in the first rail, a first lift cord connected to the spring motor unit, and a first ladder control mechanism having a first drive pulley connected to a first ladder pulley such that rotation of the first drive pulley in a first rotational direction drives rotation of the first ladder pulley and rotation of the first drive pulley in a second rotational direction drives rotation of the first ladder pulley where the first rotational direction is opposite the second rotational direction. The blind can also include a first ladder supporting the slats. The first ladder can be connected to the first ladder pulley of the first ladder control mechanism. The blind can also include a second lift cord connected to the spring motor unit, a second ladder control mechanism having a second drive pulley connected to a second ladder pulley such that rotation of the second drive pulley in the first rotational direction drives rotation of the second ladder pulley and rotation of the second drive pulley in the second rotational direction drives rotation of the second ladder pulley, and a second ladder supporting the slats that is connected to the second ladder pulley of the second ladder control mechanism. The first lift cord can extend along the first drive pulley of the first ladder control mechanism such that motion of the first lift cord along the first drive pulley during retraction of the slats drives rotation of the first drive pulley in the first rotational direction to rotate the first ladder pulley for tilting of the slats from an open position to a closed position and motion of the first lift cord along the first drive pulley during extension of the slats drives rotation of the first drive pulley in the second rotational direction to rotate the first ladder pulley for tilting of the slats from the closed position to the open position. The second lift cord can extend along the second drive pulley of the second ladder control mechanism such that motion of the second lift cord along the second drive pulley during retraction of the slats drives rotation of the second drive pulley in the second rotational direction to rotate the second ladder pulley for tilting of the slats from an open position to a closed position and motion of the second lift cord along the second drive pulley during extension of the slats drives rotation of the second drive pulley in the first rotational direction to rotate the second ladder pulley for tilting of the slats from the closed position to the open position.

In some embodiments, the first ladder can comprises a first front rail, a first rear rail and spaced apart first rungs extending between the first front rail and the first rear rail. The first front rail and the first rear rails can be segments of a cord or tape that is looped about the first ladder pulley. The second ladder can comprises a second front rail, a second rear rail and spaced apart second rungs extending between the second front rail and the second rear rail. The second front rail and the second rear rails can be segments of a cord or tape that is looped about the second ladder pulley.

The spring motor unit can be configured to include one or more spring motors. In some embodiments, the spring motor unit can include a first spring motor pulley, a second spring motor pulley, and a spring member extending between the first and second spring motor pulleys.

The venetian blind can also include other components. For instance, the blind can also include a first lift cord pulley connected to the first spring motor pulley. The first lift cord can be connected to the first lift cord pulley to be connected to the spring motor unit. The first lift cord can be connected to the first lift cord pulley such that the first lift cord is windable about the first lift cord pulley during retraction of the slats and the first lift cord is unwindable from the first lift cord pulley during extension of the slats. A second lift cord pulley can be connected to the second spring motor pulley. The second lift cord can be connected to the second lift cord pulley to be connected to the spring motor unit. The second lift cord can be connected to the second lift cord pulley such that the second lift cord is windable about the second lift cord pulley during retraction of the slats and the second lift cord is unwindable form the second lift cord pulley during extension of the slats.

The first and second ladder control mechanisms can include other components in embodiments of the blind. For instance, the first ladder control mechanism can also include a first friction pulley. The first lift cord can be routed to pass from the first drive pulley to the first friction pulley to pass along the first friction pulley and be routed to also pass from the first friction pulley to the first drive pulley. The second ladder control mechanism can include a second friction pulley. The second lift cord can be routed to pass from the second drive pulley to the second friction pulley to pass along the second friction pulley and be routed to also pass from the second friction pulley to the second drive pulley. In some embodiments, the first lift cord can be routed to form a first loop between the first drive pulley and the first friction pulley and the second lift cord can be routed to form a second loop between the second drive pulley and the second friction pulley.

The first ladder control mechanism can also include a first gear connected to the first drive pulley and a second gear connected to the first ladder pulley. The first gear can have teeth that intermesh with teeth of the second gear such that rotation of the first drive pulley drives rotation of the first ladder pulley. The second ladder control mechanism can also comprises a first gear connected to the second drive pulley and a second gear connected to the second ladder pulley. The second gear of the second ladder control mechanism can have teeth that intermesh with teeth of the second gear of the second ladder control mechanism such that rotation of the second drive pulley drives rotation of the second ladder pulley.

In other embodiments, a venetian blind can be provided to include a first rail, a plurality of slats that are moveable relative to the first rail between an extended position and a retracted position, a spring motor unit positioned in the first rail, a first lift cord connected to the spring motor unit, a first ladder supporting the slats that is connected to a first ladder pulley of a first ladder control mechanism; a second lift cord connected to the spring motor unit, and a second ladder supporting the slats that is connected to a second ladder pulley of a second ladder control mechanism. The first ladder control mechanism can include a first drive pulley connected to the first ladder pulley such that rotation of the first drive pulley in a first rotational direction drives rotation of the first ladder pulley and rotation of the first drive pulley in a second rotational direction drives rotation of the first ladder pulley. The first rotational direction can be opposite the second rotational direction. The second ladder control mechanism can include a second drive pulley connected to the second ladder pulley such that rotation of the second drive pulley in the first rotational direction drives rotation of the second ladder pulley and rotation of the second drive pulley in the second rotational direction drives rotation of the second ladder pulley. The first lift cord can extend along the first drive pulley of the first ladder control mechanism such that motion of the first lift cord along the first drive pulley during extension of the slats drives rotation of the first drive pulley in the first rotational direction to rotate the first ladder pulley for tilting of the slats from an open position to a closed position and motion of the first lift cord along the first drive pulley during retraction of the slats drives rotation of the first drive pulley in the second rotational direction to rotate the first ladder pulley for tilting of the slats from the closed position to the open position. The second lift cord can extend along the second drive pulley of the second ladder control mechanism such that motion of the second lift cord along the second drive pulley during extension of the slats drives rotation of the second drive pulley in the second rotational direction to rotate the second ladder pulley for tilting of the slats from an open position to a closed position and motion of the second lift cord along the second drive pulley during retraction of the slats drives rotation of the second drive pulley in the first rotational direction to rotate the second ladder pulley for tilting of the slats from the closed position to the open position.

The venetian blind can be configured so that the first ladder comprises a first front rail, a first rear rail and spaced apart first rungs extending between the first front rail and the first rear rail. The first front rail and the first rear rails can be segments of a cord or tape that is looped about the first ladder pulley or be separate cords or tape connected together to be coupled to the first ladder pulley. The second ladder can comprise a second front rail, a second rear rail and spaced apart second rungs extending between the second front rail and the second rear rail. The second front rail and the second rear rails can be segments of a cord or tape that is looped about the second ladder pulley or be separate cords or tape connected together for being coupled to the second ladder pulley.

The first ladder control mechanism can be configured to include a first friction pulley such that the first lift cord are routed to pass from the first drive pulley to the first friction pulley to pass along the first friction pulley and be routed to also pass from the first friction pulley to the first drive pulley such that the first lift cord forms a first loop between the first drive pulley and the first friction pulley. The first ladder control mechanism can also have a first housing such that the first drive pulley and the first ladder pulley are connected to the first housing so that a rotational axis about which the first drive pulley is rotatable is perpendicular to a rotational axis about which the first ladder pulley is rotatable and so that the first drive pulley is located below the first ladder pulley. The first ladder control mechanism can also include a first gear connected to the first drive pulley and a second gear connected to the first ladder pulley such that the first gear has teeth that intermesh with teeth of the second gear such that rotation of the first drive pulley drives rotation of the first ladder pulley.

The second ladder control mechanism can be configured to include a second friction pulley such that the second lift cord is routed to pass from the second drive pulley to the second friction pulley to pass along the second friction pulley and be routed to also pass from the second friction pulley to the second drive pulley so that the second lift cord forms a second loop between the second drive pulley and the second friction pulley. The second ladder control mechanism can also include a second housing such that the second drive pulley and the second ladder pulley are connected to the second housing so that a rotational axis about which the second drive pulley is rotatable is perpendicular to a rotational axis about which the second ladder pulley is rotatable and the second drive pulley is located below the second ladder pulley. The second ladder control mechanism can also include a first gear connected to the second drive pulley and a second gear connected to the second ladder pulley such that the first gear of the second ladder control mechanism has teeth that intermesh with teeth of the second gear of the second ladder control mechanism such that rotation of the second drive pulley drives rotation of the second ladder pulley.

First and second lift cord pulleys can also be included in the venetian blind. Other pulleys can also be located in the first rail to facilitate routing of the lift cords. In some embodiments, a first lift cord pulley can be connected to the first spring motor pulley so that the first lift cord is connected to the first lift cord pulley to be connected to the spring motor unit. The first lift cord can be windable about the first lift cord pulley during retraction of the slats and the first lift cord can be unwindable form the first lift cord pulley during extension of the slats. The second lift cord pulley can be connected to the second spring motor pulley such that the second lift cord is connected to the second lift cord pulley to be connected to the spring motor unit. The second lift cord can be windable about the second lift cord pulley during retraction of the slats and the second lift cord can be unwindable form the second lift cord pulley during extension of the slats.

Other details, objects, and advantages of the window covering, window covering positional adjustment mechanism, and methods of making and using the same will become apparent as the following description of certain exemplary embodiments thereof proceeds.

### BRIEF DESCRIPTION OF THE DRAWINGS

Exemplary embodiments of the window covering, slat control mechanism, and methods of making the same are shown in the accompanying drawings. It should be understood that like reference numbers used in the drawings may identify like components.

FIG. 1 is a perspective view of a first exemplary embodiment of the window covering in an extended position with the slats of the window covering material in an open position.

FIG. 2 is a perspective view of the first exemplary embodiment of the window covering in a retracted position.

FIG. 3 is a fragmentary exploded view of a portion of a positional control mechanism of the first exemplary embodiment of the window covering.

FIG. 4 is a perspective view of an exemplary slat control mechanism that is included in the first exemplary embodiment of the window covering.

FIG. 5 is a perspective view of an exemplary ladder mechanism that is included in the first exemplary embodiment of the window covering with a covering element removed to better illustrate internal components of the exemplary ladder control mechanism.

FIG. 6 is a perspective view of the exemplary ladder mechanism similar to FIG. 5 with a housing element removed to more clearly illustrate exemplary lift cord and ladder positioning.

FIG. 7 is a perspective view of an exemplary configuration of a first pulley 31 of the ladder control mechanisms 21 included in the first exemplary embodiment of the window covering.

FIG. 8 is a perspective view of the first exemplary embodiment of the window covering in a partially retracted position in which a lower number of slats are bunched together and the other slats are in an open position.

FIG. 9 is a perspective view of the first exemplary embodiment of the window covering in a partially retracted position in which a lower number of slats are bunched together and the other slats are tilted to a closed position.

FIG. 10 is a fragmentary exploded view of a portion of a positional control mechanism that can be included in the first exemplary embodiment of the window covering.

### DETAILED DESCRIPTION OF EXEMPLARY EMBODIMENTS

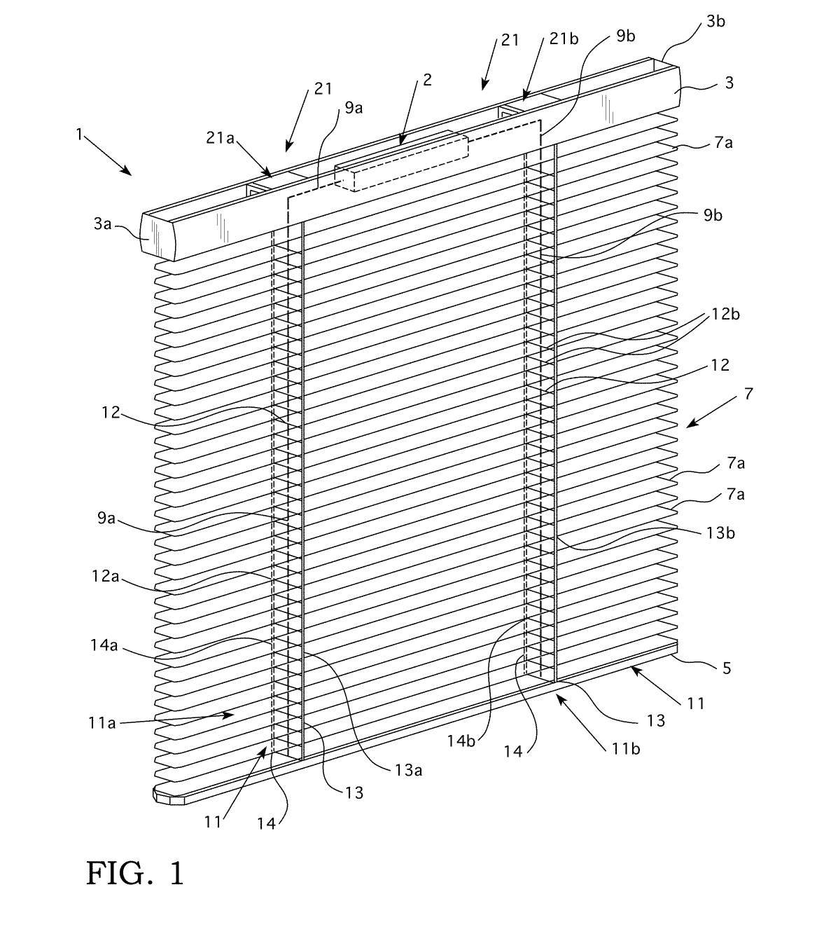

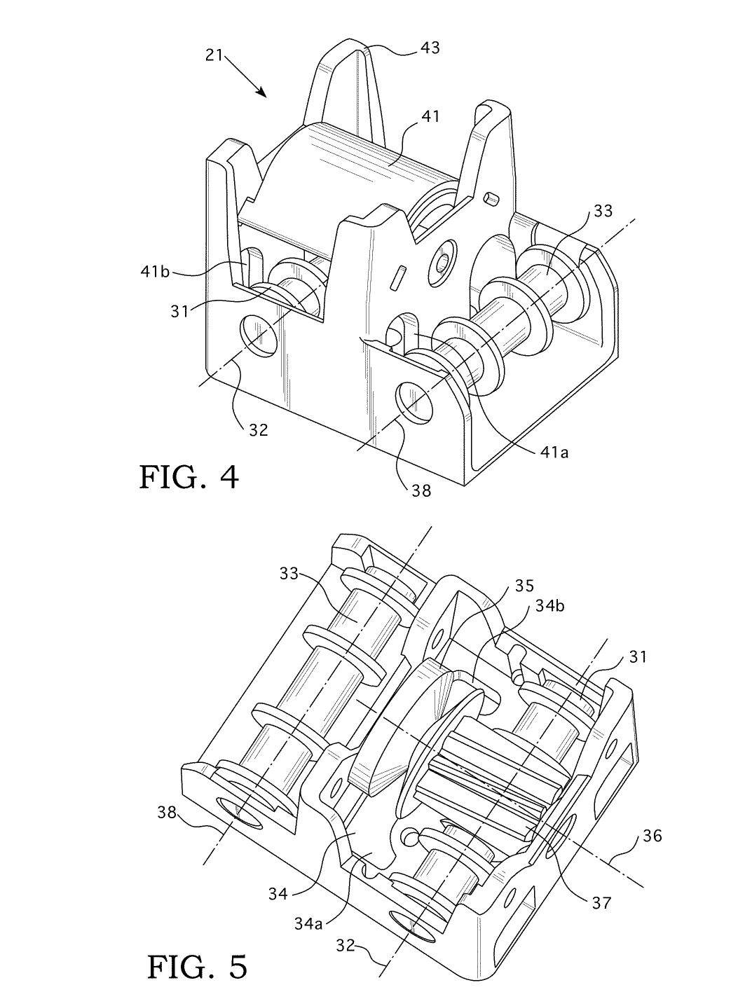

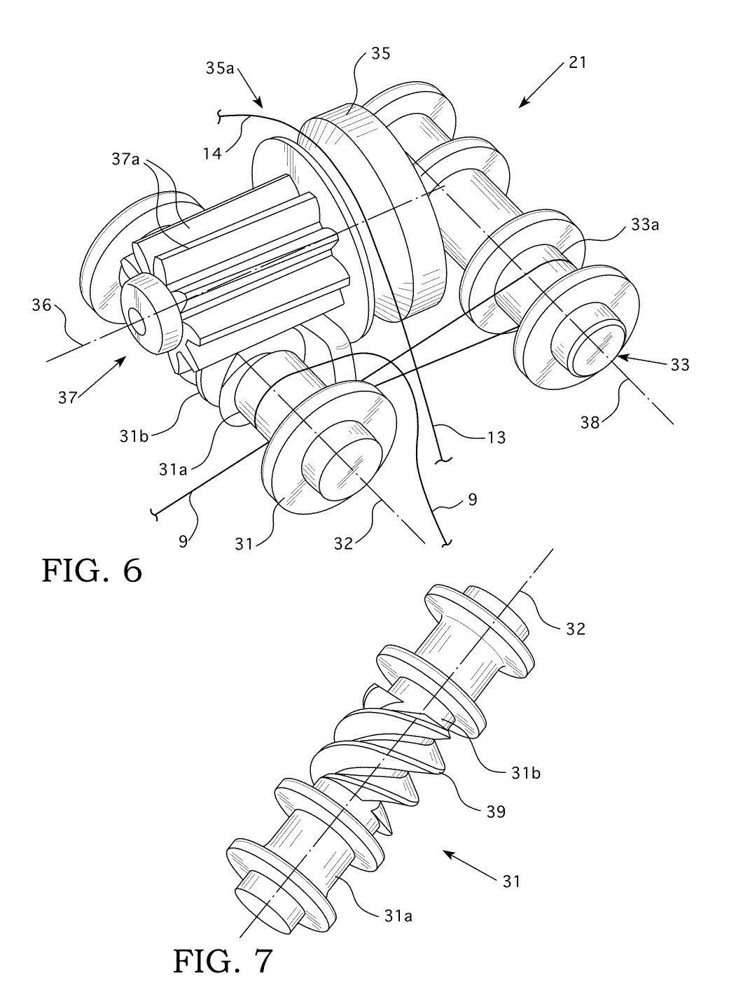

Referring to FIGS. 1-10, a window covering 1 can be configured as a blind such as a venetian blind (also referred to as a mini blind), or other type of blind or window shade. The window covering 1 can include a first rail 3 that has a first end 3a and a second end 3b that is opposite the first end 3a. The first rail can be connected to window covering material 7 that is moveable relative to the first rail between an extended, or lowered, position, and a retracted, or raised, position. The window covering material 7 can be slates 7a that are spaced apart from each other via ladders 11. Each of the ladders 11 can be composed of cord or tape to define a ladder for supporting the slats. For instance, each of the ladders 11 can have rungs 12 extending between front and rear rails 13 and 14 of the ladders 11. The front and rear rails 13 and 14 may extend between the first rail 3 and second rail 5. The front rail 13 may extend along the front sides of the slats 7a and the rear rail 14 may extend along the rear sides of the slats 7b.

The ladders 11 may include a first ladder 11a and a second ladder 11b. The first ladder 11a may be adjacent the first ends of the slats 7a and the second ladder 11b may be positioned adjacent the second ends of the slats opposite the first ends of the slats. The first ladder 11a can include first front rail 13a, first rear rail 14a and vertically spaced part first rungs 12a that extend between the first front rail 13a and first rear rail 14a. Each first rung 12a may contact or engage a respective one of the slats 7a to support an end portion of that slat. The second ladder 11b can include second front rail 13b, second rear rail 14b and vertically spaced part second rungs 12b that extend between the second front rail 13b and second rear rail 14b. Each second rung 12b may contact or engage a respective one of the slats 7a to support an end portion of that slat. Each of the second rungs 12b can be positioned to be parallel with a corresponding one of the first rungs 12a so that each slat 7a is supported by that pair of corresponding rungs so that the slat 7a can be level and extend horizontally. The rails of the first and second ladders 11a and 11b can be moved to effect tilting of the rungs 12 so that the rungs of each ladder tilt a the same time in the same way so that the slats 7a tilt between open and closed positions when the window covering material 7 is extended.

Some embodiments of the window covering 1 can be configured so that when the window covering material 7 is fully retracted, the ladders 11 may be bunched so that the rungs are close together and the slats 7a are close to each other. When in such a position, the slats may not be tilted. When the window covering material is fully extended, the first rungs 12a are spaced apart from each other and the second rungs 12b are spaced apart from each other sufficient to space the slats 7a away from each other to facilitate titling of the slats. When the window covering 1 is partially retracted, a bottommost number of slats may be positioned close to each other while slats above those bottommost slats may still be spaced apart. When in such a position, the bottommost slats 7a may not be tiltable due to the close spacing of the slats 7a and rungs. But, the spaced apart upper slats may still be tiltable upon motion of the front and rear rails 13 and 14 of the ladders 11 even though the bottommost slats that are positioned closely to each other due to the partial raising of the window covering material may not be tiltable from such motion due to their close proximity to other slats that occurs from the bunching of the bottom portion of the ladders 11 that may occur from the partial raising, or partial retracting, of the window covering material.

The front and rear rails 13 and 14 of the ladders 11 may define flexible rails of the ladders 11. For instance, the front and rear rails 13 and 14 may be separate cords that are attached to each other or segments of the same cord or may be separate tapes that are attached to each other or are segments of the same tape. The front and rear rails 13 and 14 can be flexible such that they may be scrunched up or bunched up when the window covering material is raised, or fully retracted such that slats 7a that are spaced apart from each other when the window covering material is extended are closer to each other when the window covering material is fully retracted.

The front and rear rails 13 and 14 of each ladder 11 can be tilted to effect adjustment of the orientation of the rungs 12 from extending horizontally between the front and rear rails 13 and 14 to extending at an incline or a decline between those rails so that the slats 7a that rest on the rungs 12 or are supported by the rungs 12 are moveable between a horizontal position, or open position, and a tilted position, or closed position. When in the open position, the edges of the slats 7a may be generally parallel with each other such that the slats are horizontally oriented. When in the closed position, a rear edge of each slat may be tilted to be above or below the front edge of the slot 7a. Each slat 7a may also have a left edge and a right edge on opposite ends of the slat that extend between the front and rear edges. When in the horizontal position, the left and right edges may be parallel with each other. When in the closed position, or tilted position, the right and left edges may extend along an inclined angle or a declined angle such that the front edge is above or below the rear edge.

The window covering 1 can also include a bottom rail 5. Bottom ends of the front and rear rails 13 and 14 of the ladders 11 can be connected to the bottom rail 5. In some embodiments, the bottom rail 5 can be configured as a lowest slat of the window covering material 7.

The window covering 1 can include a spring motor unit 2 positioned in the first rail 3. The spring motor unit 2 can be connected to lift cords 9 that may extend from the first rail 3 through the slats 7a or by the slats 7a to the bottom rail 5 or the bottommost slat of the window covering material 7. The lift cords 9 may be moveable so that a further extension of the lift cords 9 out of the first rail may occur to facilitate lowering, or extension, of the window covering material 7 and a retraction of the window covering material 7 can be effected by retracting the lift cords or collecting the lift cords back into the first rail 3 via the spring motor unit 2.

The lift cords 9 may include a first lift cord 9a and a second lift cord 9b. There may also be more than two lift cords, such as three lift cords, four lift cords, or more than four lift cords. Each lift cord may be configured as a separate cord. In other embodiments, the first and second lift cords 9a and 9b may be configured as end portion segments of the same cord that has its central portion coupled to the spring motor unit 2 to effect raising and lowering of the first and second lift cods 9a and 9b. For instance, a central portion of a single lift cord can be connected to a connector for connecting the single cord to the spring motor unit 2 so that the first and second segments extending from that single cord function as first and second lift cords. An example of such a connection is disclosed in U.S. Pat. No. 7,950,437. The lift cords 9 can also be configured as flexible elements such as polymeric filaments, tape, or other type of flexible elongated elements that function like cords or cord segments.

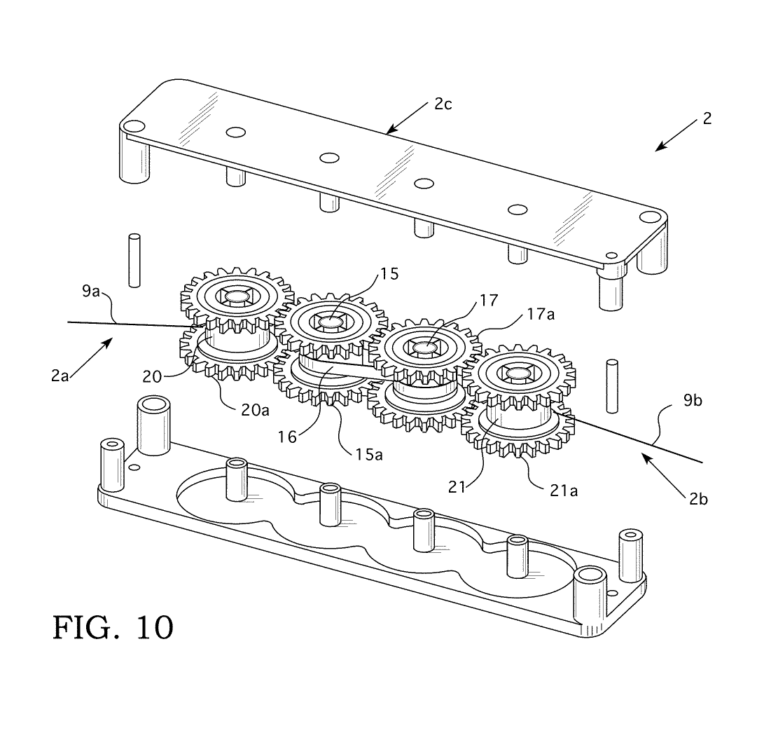

In some embodiments, the each lift cord can be connected to a respective lift cord pulley that is coupled to a spring motor pulley of the spring motor of the spring motor unit 2. For example, as may be seen from FIGS. 3 and 10, the spring motor unit 2 can include a spring motor that includes a spring member 16 that extends between a first spring motor pulley 15 and a second spring motor pulley 19. A first end of the spring member 16 can be coupled to the first spring motor pulley 15 and the second end of the spring member 16 that is opposite its first end can be coupled to the second spring motor pulley 17. The first and second spring motor pulleys 15 and 17 may each have teeth that extend from a side or other portion of the pulley. The teeth 15a of the first spring motor pulley 15 may intermesh with the teeth 17a of the second spring motor pulley 17 so that both pulleys are rotatable at the same time in the same direction at the same rate of speed or substantially the same rate of speed (e.g. within 5%, within 10% or within 15% of being the same rate of speed). The intermeshing of the teeth may also add friction into the window covering material positional adjustment system of the window covering 1.

The first spring motor pulley 15 can be connected to a first lift cord pulley 20 via gear teeth 15a that may extend from a side of the first spring motor pulley 15 to intermesh with gear teeth 20a that extend from a side of the first lift cord pulley 20. Alternatively, the first lift cord pulley 20 can be connected to a first gear 18 (shown in broken line in FIG. 3) that has teeth that intermesh with the teeth 15a that extend from the first spring motor pulley 15 so that the first lift cord pulley 20 can be coupled to the first spring motor pulley 15. The second spring motor pulley 17 can be connected to a second lift cord pulley 21 via gear teeth 17a that may extend from a side of the second spring motor pulley 17 to intermesh with gear teeth 21a that extend from a side of the second lift cord pulley 21. Alternatively, the second lift cord pulley 21 can be connected to a second gear 19 (shown in broken line in FIG. 3) that has teeth that intermesh with the teeth 17a that extend from the second spring motor pulley 17 to be coupled to the second spring motor pulley 17. In yet other embodiments, the first spring motor pulley 15 can be coupled to the first lift cord pulley 20 via at least one first gear 18 positioned between the first spring motor pulley 15 and the first lift cord pulley 20 that is coupled between those pulleys via intermeshing gear teeth and/or other attachment mechanisms. The second spring motor pulley 17 can also be coupled to the second lift cord pulley 21 via at least one second gear 19 positioned between the second spring motor pulley 17 and the second lift cord pulley 21 that is coupled between those pulleys via intermeshing gear teeth and/or other attachment mechanisms. In yet other embodiments, the first lift cord pulley 20 may be positioned on the same rotational axle as the first spring motor pulley such that the first spring motor pulley 15 and the first lift cord pulley 20 are pulley portions of a double pulley or triple pulley. The second lift cord pulley 21 can be coupled to the second spring motor pulley 17 about the same axle so that they both rotate on the same rotational axis in a similar manner such that they are each portions of a double or triple pulley as well in such an alternative embodiment.

First and second gears 18 and 19 can be configured to define a gear ratio between rotation of a spring motor pulley and a lift cord pulley. For instance, the first and second gears can be configured so that when a spring motor pulley rotates one full revolution, the lift cord pulley to which it is attached via one or more intermeshed gears rotates two full revolutions. Such a configuration can permit a shorter length spring member 16 to be used in the spring motor unit 2 and/or to permit the same spring member 16 to be used in designs that have very short lengths of window covering material and also very long lengths of window covering material. The utilization of one or more first gears 18 and one or more second gears 19 can also be configured to add friction into the operation of the spring motor unit 2 for the extending and retracting of the window covering material, which can help facilitate improved precision for height adjustment in some embodiments of the window covering.

The first lift cord pulley 20 may have a first end of a first lift cord 9a attached thereto such that the first lift cord 9a is windable about the first lift cord pulley 20 when the first lift cord pulley 20 rotates in the first rotational direction and is unwindable from the first lift cord pulley 20 via rotation of the pulley in the second rotational direction. The second lift cord pulley 21 may have a first end of a second lift cord 9b attached thereto such that the second lift cord 9b is windable about the second lift cord pulley 21 when the pulley is rotated in the first rotational direction and is unwindable from the second lift cord pulley 21 via rotation of the pulley in the second rotational direction.

The window covering 1 can also include a slat control mechanism. The slat control mechanism can include ladder control mechanisms 21 positioned in the first rail 3 by opposite sides of the spring motor unit 2. For instance, a first ladder control mechanism 21a can be positioned adjacent a first side 2a of the spring motor unit 2 adjacent the first end 3a of the first rail and a second ladder control mechanism 21b can be positioned adjacent a second side 2b of the spring motor unit 2 adjacent the second end 3b of the first rail. In some embodiments, the first ladder control mechanism 21a, spring motor unit 2, and second ladder control mechanism 21b can be spaced apart from each other and linearly aligned within the first rail 3. The first lift cord 9a that is connected to the spring motor unit 2 can extend from the first lift cord pulley 20 to the first ladder control mechanism 21a as that lift cord extends along a path within the first rail 3 prior to exiting the first rail 3 to pass through slats 7a to the second rail 5. The second lift cord 9b that is connected to the spring motor unit 2 can extend from the second lift cord pulley 21 to the second ladder control mechanism 21b as it extends from the second lift cord pulley 21 along a path within the first rail 3 prior to exiting the first rail to pass through slats 7a to the second rail 5.

Each ladder control mechanism 21 can be configured to effect a motion of the front and rear rails 13 and 14 of the ladder 11 to which it is attached to adjust the orientation of the rungs 12 of that ladder 11 between horizontal and tilted positions to effect tilting of the slats 7a that are supported by the rungs 12 between closed and opened positions while a lift cord is moved to effect raising or lowering of the window covering material 7 such that the motion of the lift cord actuates the tilting of the slats. Such a configuration can permit a slat control mechanism that includes the ladder control mechanisms 21 to be integrated into the height adjustment mechanism of the window covering 1 to provide a positional adjustment mechanism that facilitates a cordless and wandless control of the tilted position of the slats and the extent to which the window covering material 7 is extended or retracted (e.g. wandless and cordless actuation of height adjustment and tilting adjustment of the slats 7a) so that tilting of the slats 7a can be actuated at the same time the window covering material 7 is extended or retracted.

Each ladder control mechanism 21 can include a housing that supports a plurality of pulleys. Each of the pulleys can be configured as a single pulley, a double pulley, a triple pulley, a rotor, a roller, or other type of pulley configuration. Each of the pulleys can be supported by the housing to be rotational in opposite directions (e.g. a first rotational direction and a second rotational direction that is opposite the first rotational direction).

The pulleys of each ladder control mechanism 21 can include a first pulley 31, a second pulley 33, and a third pulley 35. The first pulley 31 can have a first rotational axis 32 about which it is rotatable, the second pulley 33 can have a second axis 38 of rotation about which it is rotatable, and the third pulley 35 can have a third axis 36 of rotation about which it is rotatable. The first and second pulleys 31 and 33 can be supported by the housing to have parallel axes of rotation or substantially parallel axes of rotation (e.g. within 15° of being parallel). For instance the first axis 32 of rotation may be parallel to the second axis 38 of rotation. The third pulley 35 can be supported by the housing to have a rotational axis that is perpendicular or substantially perpendicular (e.g. within 15° of being perpendicular) to the axes of rotation of the first and second pulleys 31 and 33. For instance, the third axis 36 of rotation can be perpendicular or substantially perpendicular to the first axis 32 of rotation and can also be perpendicular or substantially perpendicular to the second axis of rotation 38.

The third pulley 35 can be positioned to be above the first and second pulleys 31 and 33 and can also be configured to be located between the first and second pulleys 31 and 33. The third pulley can be configured to be connected to a ladder so that the front and rear rails 13 and 14 of a ladder extend from opposite sides of the third pulley for extending out of the first rail 3 on opposite front and rear sides of the slats and have their terminal ends connected to the second rail adjacent the front and rear sides of the second rail. The third pulley 35 can be considered a ladder pulley in some embodiments. In some embodiments, the front and rear rails 13 and 14 can be segments of the same cord that has its middle portion looped about or entrained about the third pulley and its opposite terminal ends connected to opposite sides of the second rail 5. The first and second pulleys 31 and 33 can be configured so that a lift cord can pass along these pulleys and/or entrain about those pulleys as it extends from a lift cord pulley connected to the spring motor unit 2 to the second rail 5.

The third pulley 35 can be connected to the first pulley 31 so that the third pulley rotates about the third axis 36 when the first pulley 31 rotates about the first axis 32 so that rotational motion of the first pulley 31 drives rotational motion of the third pulley 35. In some embodiments, a plurality of gear teeth 37 may extend from the third pulley 35 to intermesh with gear teeth that extend from the first pulley 31 to provide such a connection. In some embodiments, such gear teeth 37 may extend from gears that are connected to or form a portion of those pulleys. For instance, the first pulley 31 can have a first portion 31a that is sized and configured to receive and entrain a portion of a lift cord 9 and a second portion 31b that is configured to have gear teeth 39 extend therefrom to engage gear teeth 37 extending from the third pulley 35. In other embodiments, a gear may be connected to the first pulley 31 that has teeth 39 that extend to intermesh with gear teeth 37 of a gear connected to the third pulley 35.

The housing of each ladder control mechanism 21 can include a cover 41 that is positioned to be located above the third pulley 35 to cover that pulley and can include a first opening 41b that is sized to permit a lift cord to pass into the housing and a second opening 41b that is sized to permit the lift cord to pass out of a portion of the housing to extend between the first and second pulleys 31 and 33. A bottom portion of the housing can define at least one bottom opening 34. The bottom opening can include a first opening portion 34a that is configured to permit the front rail 13 to pass from the third pulley 35 out of housing so it can pass through the first rail 3, alongside the slats 7a. and to the second rail 5. The bottom opening 34 can also include a second opening portion 34b that is configured to permit the rear rail 14 to pass from the third pulley 35 out of housing so it can pass through the first rail 3, alongside the slats 7a, and to the second rail 5.

The lift cord 9 passed to each ladder control mechanism 21 can be routed along the first and second pulleys 31 and 33 such that the motion of the lift cord to retract or extend the window covering material causes the lift cord to rotate these pulleys. For example, the lift cord 9 can pass through second opening 41b to pass along the first pulley 31 and then pass along the second pulley 33 to wrap about that second pulley 33 and return to the first pulley 31 to pass back along that pulley before being routed out of the housing and through the first rail to pass through the slats 7a. In some embodiments, the lift cord may be routed to form one or more loops between the first and second pulleys 31 and 33 via those pulleys' first portions 31a and 33a that are sized and configured to receive and entrain the lift cord before the lift cord is passed out of the housing of the ladder control mechanism 21 for being routed through the slats to the second rail 5. In other embodiments, the lift cord may be routed to pass over the first portions 31a and 33a of the first and second pulleys 31 and 33 along a linear path prior to being routed out of the first rail 3 through the slats 7a and to the second rail 5. The routing of the lift cord to pass between the first and second pulleys 31 and 33 can be configured to induce a desired level of friction when the lift cord is moved along those pulleys.

The lift cord 9 can be routed so that motion of the lift cord 9 that occurs as the cord is wound upon a lift cord pulley to which it is attached for raising, or retracting, of the slats 7a causes the first and second pulleys 31 and 33 to rotate in a first rotational direction as that lift cord passes along those first and second pulleys 31 and 33. The rotational motion of the first pulley 31 can also drive rotational motion of the third pulley 35 at the same time the lift cord is moving during retraction via the connection between the first and third pulleys 31 and 35 so that the third pulley 35 rotates in a first rotational direction. This rotational motion of the third pulley 35 can cause the front and rear rails 13 and 14 to move to adjust the orientation of the rungs 12 that extend between those rails so that the rungs move from a horizontal position to a tilted position or from a tilted position to a horizontal position as the window covering material 7 is raised, or retracted, so that tilting of the slats occurs as the window covering material is raised, or retracted.

The lift cord's routing along the first and second pulleys 31 and 33 can also be configured so that when the lift cord moves from unwinding off of the lift cord pulley to which it is attached for greater extension out of the first rail for extending, or lowering of the slats 7a, the motion of the lift cord drives rotation of the first and second pulleys 31 and 33 in a second rotational direction that is opposite the first rotational direction. The rotation of the first pulley 31 in its second rotational direction can drive rotation of the third pulley 35 in its second rotational direction as well. This rotational motion of the third pulley causes the front and rear rails 13 and 14 to move so that the orientation of the rungs 12 extending between those rails is adjusted from a horizontal orientation to a tilted orientation or vice versa so that the slats are tiltable as the window covering material 7 is lowered, or extended.

In some embodiments, the first pulley 31 can be considered a drive pulley of the ladder control mechanism 21 as it is configured to drive motion of the third pulley 35 and the second pulley 33 can be considered a friction pulley as it helps route the lift cord to facilitate inducement of a desired level of friction upon motion of the lift cord for raising or lowering of the window covering material 7. The third pulley 35 can be considered a ladder pulley for such embodiments as it is coupled to a ladder 11 to move to actuate motion of the ladder for adjusting the tilt, or orientation of the slats supported by that ladder 11.

While the third pulley 33 can be utilized to increase the friction in a positional adjustment mechanism of a blind to help provide a desired amount of friction for facilitating a desired level of precision in the height adjustment capacity of the spring motor unit 2, it may not always be needed to meet a set of design criteria. For such embodiments, the ladder control mechanism 21 may only include the first and third pulleys 31 and 35. For embodiments of the ladder control mechanism 21 that only has two pulleys, the first pulley and the third pulley 35, the third pulley 35 could be considered the ladder control mechanism's second pulley.

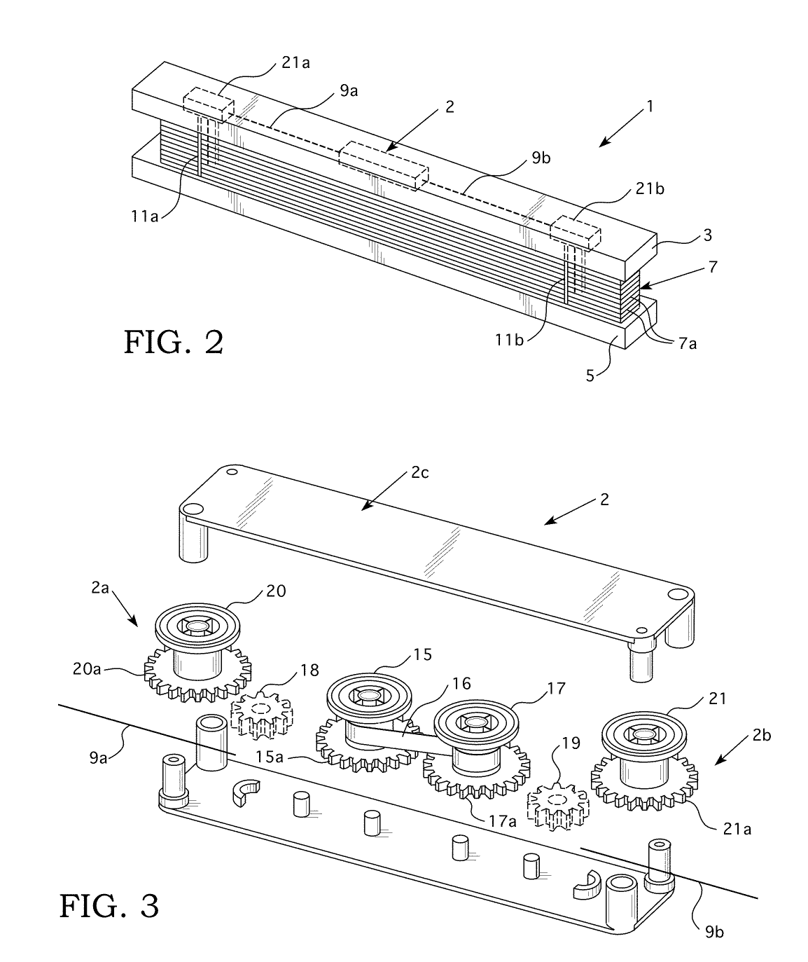

Referring to FIGS. 1 and 2, the motion of the first and second lift cords 9a and 9b during retraction and extension of the window covering material 7 can be configured to drive tilting of the slats 7a between open positions in which the slats are oriented horizontally so that there is a space between immediately adjacent slats and a closed position in which the slats are tilted so that their front edges are above or below their rear edges and such that a slat may contact one or more immediately adjacent slats to help block the opening that exists between the slats when they are in their open tilted position. For instance, the first lift cord 9a may be routed along the first and second pulleys 31 and 33 of the first ladder control mechanism 21a so that motion of the first lift cord 9a drives motion of the first and second pulleys 31 and 33 of the first ladder control mechanism 21a in a first rotational direction during retraction of the slats and in a second rotational direction during extension of the slats. The rotation of the first pulley 31 can drive rotation of the third pulley 35 of the first ladder control mechanism 21a in a first rotational direction during retraction of the slats and in a second rotational direction during extension of the slats so that the first front and rear rails 13a and 14a of the first ladder 11a move to alter the orientation of the first rungs 12a that extend between the first front and rear rails 13a and 14a for changing the tilted position of the slats 7a during height adjustment of the slats.

The second lift cord 9b may be routed along the first and second pulleys 31 and 33 of the second ladder control mechanism 21b so that motion of the second lift cord 9b drives motion of the first and second pulleys 31 and 33 of the second ladder control mechanism 21b in the second rotational direction during retraction of the slats and in the first rotational direction during extension of the slats. As the second ladder control mechanism 21b may be on an opposite side of the spring motor 2 from the first ladder control mechanism 21a and the first and second lift cords 9a and 9b may extend from opposite sides of the spring motor unit 2, the rotational direction motions of the first and second pulleys may mirror those of the first and second pulleys 31 and 33 of the first ladder control mechanism 21a (e.g. the first and second pulleys 31 and 33 of the second ladder control mechanism 21b may rotate in the second direction when the first and second pulleys 31 and 33 of the first ladder control mechanism 21a rotate in the first rotational direction and the first and second pulleys 31 and 33 of the second ladder control mechanism 21b may rotate in the first direction when the first and second pulleys 31 and 33 of the first ladder control mechanism 21a rotate in the second rotational direction). The rotation of the first pulley 31 of the second ladder control mechanism 21b can drive rotation of the third pulley 35 of the second ladder control mechanism 21b in a rotational direction so that the second front and rear rails 13b and 14b of the second ladder 11b move to alter the orientation of the second rungs 12b that extend between the second front and rear rails 13b and 14b for changing the tilted position of the slats 7a at the same time and at the same rate of tilting and in the same direction of tilting as the third pulley 35 of the first ladder control mechanism 21a that occurs during extension of the slats. It should be understood that while the rotation of the first and second pulleys 31 and 33 of the second ladder control mechanism 21b may mirror the rotational directions of the first and second pulleys 31 and 33 of the first ladder control mechanism 21a, the rotational direction of the third pulleys 35 in each ladder control mechanism 21 may be configured to rotate in the same first rotational direction during retraction of the slats and in the same second rotational direction during extension of the slats so that the rungs of the ladders 11 are tilted in the same orientation at the same time via motion of the first and second lift cords 9a and 9b that occurs during extension and retraction of the window covering material (e.g. lowering and raising of a blind).

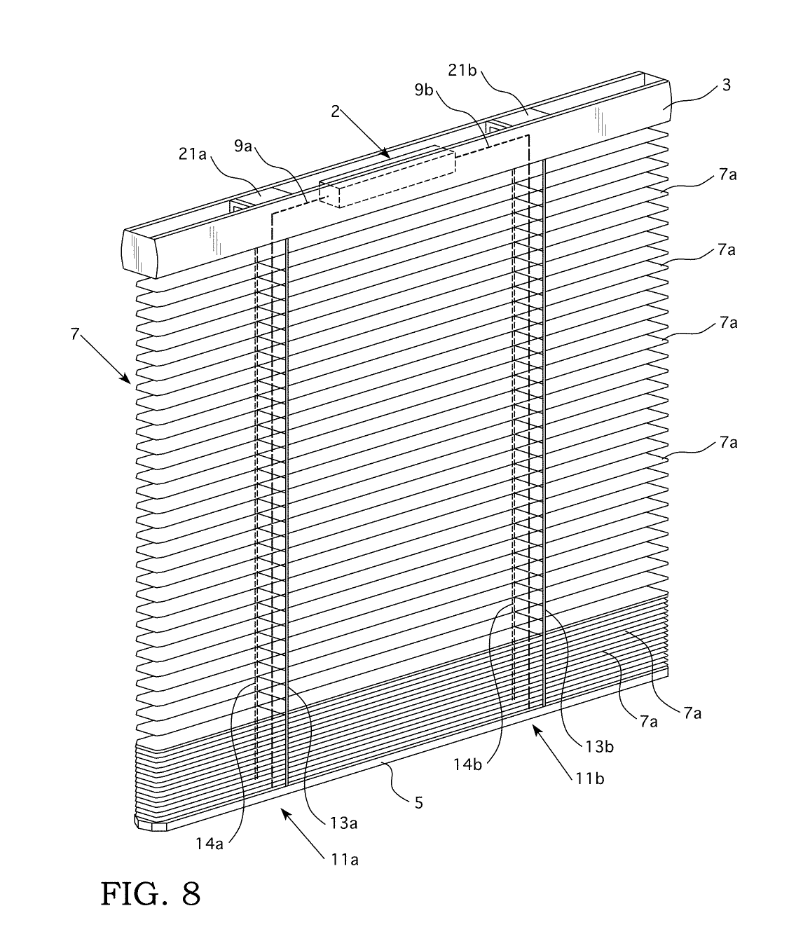

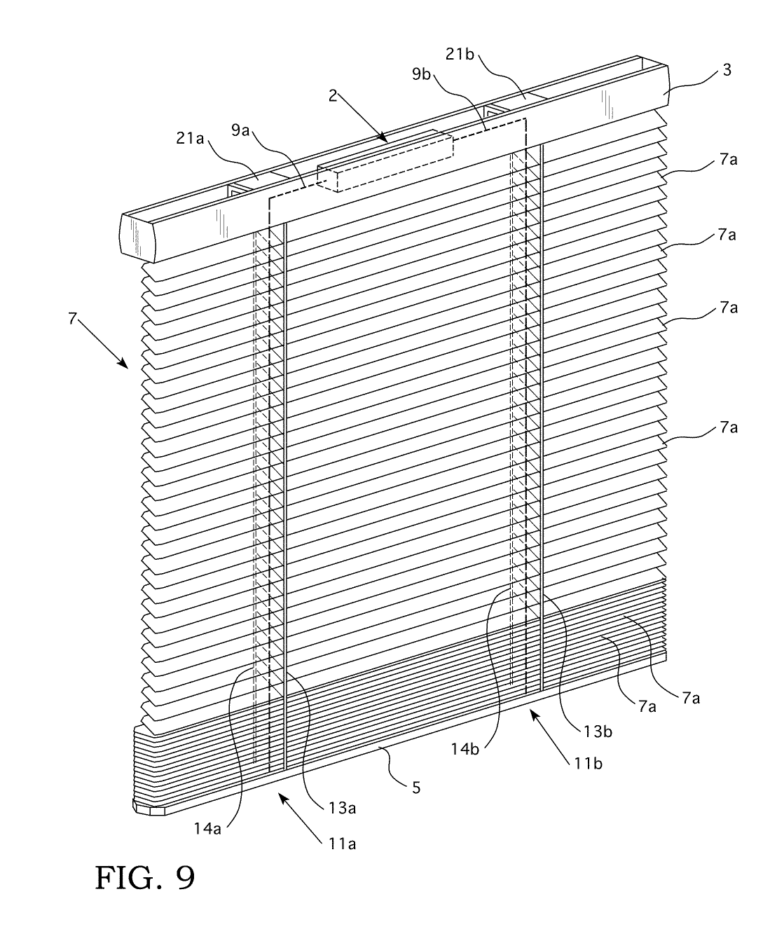

The spring motor unit 2 can be configured so that a user may manipulate the window covering material or second rail 5 to provide a downward force that overcomes the biasing force of the spring member 16 to lower the window covering material so that the slats 7a extend to a lower position. The lowering of the slats 7a can result in the lift cords 9 being extended out of the first rail, which can drive rotation of the lift cord pulleys for rotating a first direction for unwinding of the lift cords. This rotation of the lift cord pulleys can drive rotation of the spring motor pulleys in the first rotational direction as well, which can cause the spring member 16 to unwind from one of the spring member pulleys to which it is connected and further wind about the other spring motor pulley to which it is connected. After the user removes this force, the spring member 16 of the spring motor unit may provide a biasing force that maintains the slats in the user selected position. During the lowering of the slats, the slats may be tilted via motion of the lift cords from an open position to a tilted position and/or vice versa. A user may also raise the slats to retract the slats by providing an upward force on the slats by holding the second rail 5 or slats and pushing the slats upwardly. The upward force may permit the biasing force of the spring member 16 to be greater than the weight of the slats so that the spring member moves to wrap further about one of the first and second spring member pulleys 15 or 17 to drive rotation of those pulleys in a second rotational direction. This motion of the spring motor pulleys can drive rotation of the lift cord pulleys to which they are attached to rotate in the second rotational direction to wind the lift cords about those pulleys for retraction of the lift cords for raising of the slats. This motion of the lift cords 9 during the raising of the slats 7a can drive titling of the slats 7a from a tilted, closed position to a horizontal, open position and/or vice versa. As may be appreciated from FIGS. 8 and 9, a lower portion of the slats that may be bunched together during retraction or extension of the slats that occurs when the slats are raised or lowered. The bunched up portion may not tilt during the retraction or extension of the slats as the bunching of those slats may position those slats in contact with each other to prevent such tilting. The slats located above the bunched up portion may tilt during the retraction. During extension, as slats are spaced apart from the bunched up portion, the slats will be positioned via the ladders to have the tilted position of the tiled slats located above those slats.

It should be appreciated that embodiments of the window covering 1, slat control mechanism, ladder control mechanisms 21, and method of making and using the window covering 1 can vary to account for different design objectives. For example, the slats may be composed of metal or polymeric material or may have various different cross sectional shapes. As another example, the first rail 3 can be composed of a wood, be an extruded metal rail, or be a polymeric rail and also have any number of different structural shapes and configurations (e.g. an elongated beam, a bar, a rod, etc.). The first rail 3 may have an internal conduit defined therein, may have a channel, and may have a cross section that is rounded, circular, oval, polygonal, or have another type of shape. As another example, the second rail 5 can be composed of a wood, be an extruded metal rail, or be a polymeric rail and also have any number of different structural shapes and configurations (e.g. an elongated beam, a bar, a rod, etc.). The second rail 5 may have an internal conduit defined therein, may have a channel, or may be a solid structure.

In embodiments of the window covering that may utilize more than two lift cords or more than two ladders. For embodiments that have more than two ladder control mechanisms, the window covering may have more than two ladder control mechanisms 21. Each ladder control mechanism 21 may be configured to only be coupled to a single respective lift cord or multiple ladder control mechanisms may each be coupled to the same lift cord via that lift cord passing along their first pulleys 31. As yet another example, each ladder may be configured as a ladder cord that is composed of a single cord or single tape that has cord segments or tape segments to define the front and rear rails 13 and 14. In other embodiments, the ladders 11 may each be configured as a ladder cord that includes a first cord or tape that is configured as the front rail 13 that is coupled to a second cord or tape that is configured as the rear rail 14. The rungs 12 may be tape, cord, or other rung-element that extends between the front and rear rails 13 and 14 for supporting the slats and facilitating a control of the orientation of those slats. Thus, while certain exemplary embodiments of window covering, slat control mechanism, and methods of making and using the same have been shown and described above, it is to be distinctly understood that the invention is not limited thereto but may be otherwise variously embodied and practiced within the scope of the following claims.

1. A window covering comprising:
a first rail;
a spring motor unit positioned in the first rail;
a first lift cord connected to the spring motor unit;
a first ladder control mechanism having a friction pulley, a drive pulley, and a ladder pulley, the drive pulley connected to the ladder pulley such that rotation of the drive pulley in a first rotational direction drives rotation of the ladder pulley and rotation of the drive pulley in a second rotational direction also drives rotation of the ladder pulley, the first rotational direction being opposite the second rotational direction, the first lift cord being routed to pass between the drive pulley and the friction pulley such that the first lift cord passes along the friction pulley and the drive pulley without being entrained by the ladder pulley;
a first ladder supporting a plurality of slats, the first ladder connected to the ladder pulley of the first ladder control mechanism;
the plurality of slats being moveable relative to the first rail, the slats moveable between an extended position and a retracted position; and
the first lift cord extending along the drive pulley of the first ladder control mechanism such that motion of the first lift cord along the drive pulley during one of retraction and extension of the slats drives rotation of the drive pulley in the first rotational direction to rotate the ladder pulley for tilting of the slats from an open position to a closed position and motion of the lift cord along the drive pulley during the other of retraction and extension of the slats drives rotation of the drive pulley in the second rotational direction to rotate the ladder pulley for tilting of the slats from the closed position to the open position.

2. The window covering of claim 1, wherein the the first lift cord extends horizontally from the friction pulley to the drive pulley.

3. The window covering of claim 2, wherein the first lift cord extends linearly between the drive pulley and the friction pulley.

4. The window covering of claim 2, wherein the first ladder control mechanism also comprises:
a first gear connected to the drive pulley and a second gear connected to the ladder pulley, the first gear having teeth that intermesh with teeth of the second gear such that rotation of the drive pulley drives rotation of the ladder pulley.

5. The window covering of claim 4, wherein the first ladder control mechanism also comprises:
a housing, the drive pulley and the ladder pulley connected to the housing such that a rotational axis about which the drive pulley is rotatable is perpendicular to a rotational axis about which the ladder pulley is rotatable.

6. The window covering of claim 5, wherein the ladder pulley is located above the drive pulley.

7. The window covering of claim 1, wherein the first lift cord extends linearly between the friction pulley.

8. The window covering of claim 1, wherein the first lift cord is routed between the friction pulley and the drive pulley such that the first lift cord forms a first loop between the drive pulley and the friction pulley.

9. The window covering of claim 1, wherein the slats are comprised of metal or a polymeric material.

10. The window covering of claim 1, wherein the spring motor unit comprises:
a first spring motor pulley;
a second spring motor pulley; and
a spring member extending between the first and second spring motor pulleys.

11. The window covering of claim 10, comprising:
a first lift cord pulley connected to the first spring motor pulley, the first lift cord connected to the first lift cord pulley to be connected to the spring motor unit, the first lift cord being windable about the first lift cord pulley during retraction of the slats and the first lift cord being unwindable form the first lift cord pulley during extension of the slats.

12. The window covering of claim 1, wherein the first ladder comprises a front rail, a rear rail and spaced apart rungs extending between the front and rear rails, the front and rear rails being segments of a cord or tape.

13. A venetian blind comprising:
a first rail;
a plurality of slats, the slats moveable relative to the first rail between an extended position and a retracted position;
a spring motor unit positioned in the first rail;
a first lift cord connected to the spring motor unit;
a first ladder control mechanism having a first friction pulley, a first drive pulley, and a first ladder pulley, the first drive pulley connected to the first ladder pulley such that rotation of the first drive pulley in a first rotational direction drives rotation of the first ladder pulley and rotation of the first drive pulley in a second rotational direction drives rotation of the first ladder pulley, the first rotational direction being opposite the second rotational direction, the first lift cord being routed to pass between the first drive pulley and the first friction pulley such that the first lift cord passes along the first friction pulley and the first drive pulley without being entrained by the first ladder pulley;
a first ladder supporting the slats, the first ladder connected to the first ladder pulley of the first ladder control mechanism;
a second lift cord connected to the spring motor unit;
a second ladder control mechanism having a second friction pulley, a second drive pulley, and a second ladder pulley, the second drive pulley connected to the second ladder pulley such that rotation of the second drive pulley in the first rotational direction drives rotation of the second ladder pulley and rotation of the second drive pulley in the second rotational direction drives rotation of the second ladder pulley, the second lift cord being routed to pass between the second drive pulley and the second friction pulley such that the second lift cord passes along the second friction pulley and the second drive pulley without being entrained by the second ladder pulley;
a second ladder supporting the slats, the second ladder connected to the second ladder pulley of the second ladder control mechanism;
the first lift cord extending along the first drive pulley of the first ladder control mechanism such that motion of the first lift cord along the first drive pulley during retraction of the slats drives rotation of the first drive pulley in the first rotational direction to rotate the first ladder pulley for tilting of the slats from an open position to a closed position and motion of the first lift cord along the first drive pulley during extension of the slats drives rotation of the first drive pulley in the second rotational direction to rotate the first ladder pulley for tilting of the slats from the closed position to the open position; and
the second lift cord extending along the second drive pulley of the second ladder control mechanism such that motion of the second lift cord along the second drive pulley during retraction of the slats drives rotation of the second drive pulley in the second rotational direction to rotate the second ladder pulley for tilting of the slats from an open position to a closed position and motion of the second lift cord along the second drive pulley during extension of the slats drives rotation of the second drive pulley in the first rotational direction to rotate the second ladder pulley for tilting of the slats from the closed position to the open position.

14. The venetian blind of claim 13, wherein the first ladder comprises a first front rail, a first rear rail and spaced apart first rungs extending between the first front rail and the first rear rail, the first front rail and the first rear rails being segments of a cord or tape that is looped about the first ladder pulley; and
wherein the second ladder comprises a second front rail, a second rear rail and spaced apart second rungs extending between the second front rail and the second rear rail, the second front rail and the second rear rails being segments of a cord or tape that is looped about the second ladder pulley.

15. The venetian blind of claim 13, wherein the spring motor unit comprises:
a first spring motor pulley;
a second spring motor pulley; and
a spring member extending between the first and second spring motor pulleys; and the venetian blind comprises:
a first lift cord pulley connected to the first spring motor pulley, the first lift cord connected to the first lift cord pulley to be connected to the spring motor unit, the first lift cord being windable about the first lift cord pulley during retraction of the slats and the first lift cord being unwindable form the first lift cord pulley during extension of the slats; and
a second lift cord pulley connected to the second spring motor pulley, the second lift cord connected to the second lift cord pulley to be connected to the spring motor unit, the second lift cord being windable about the second lift cord pulley during retraction of the slats and the second lift cord being unwindable form the second lift cord pulley during extension of the slats.

16. The venetian blind of claim 13, wherein: 15, wherein:
the first lift cord extends linearly between the first friction pulley and the first drive pulley; and
the second lift cord extends linearly between the second friction pulley and the second drive pulley.

17. The venetian blind of claim 13, wherein the first lift cord is routed between the first drive pulley and the first friction pulley such that the first lift cord forms a first loop between the first drive pulley and the first friction pulley and the second lift cord is routed between the second drive pulley and the second friction pulley such that the second lift cord forms a second loop between the second drive pulley and the second friction pulley.

18. The venetian blind of claim of claim 17, wherein:
the first ladder control mechanism also comprises a first gear connected to the first drive pulley and a second gear connected to the first ladder pulley, the first gear having teeth that intermesh with teeth of the second gear such that rotation of the first drive pulley drives rotation of the first ladder pulley; and
the second ladder control mechanism also comprises a first gear connected to the second drive pulley and a second gear connected to the second ladder pulley, the second gear of the second ladder control mechanism having teeth that intermesh with teeth of the second gear of the second ladder control mechanism such that rotation of the second drive pulley drives rotation of the second ladder pulley.

19. A venetian blind comprising:
a first rail;
a plurality of slats, the slats moveable relative to the first rail between an extended position and a retracted position;
a spring motor unit positioned in the first rail;
a first lift cord connected to the spring motor unit;
a first ladder control mechanism having a first friction pulley, a first drive pulley and a first ladder pulley, the first drive pulley connected to the first ladder pulley such that rotation of the first drive pulley in a first rotational direction drives rotation of the first ladder pulley and rotation of the first drive pulley in a second rotational direction drives rotation of the first ladder pulley, the first rotational direction being opposite the second rotational direction, the first lift cord being routed to pass between the first drive pulley and the first friction pulley such that the first lift cord passes along the first friction pulley and the first drive pulley without being entrained by the first ladder pulley;
a first ladder supporting the slats, the first ladder connected to the first ladder pulley of the first ladder control mechanism;
a second lift cord connected to the spring motor unit;
a second ladder control mechanism having a second friction pulley, a second drive pulley, and a second ladder pulley, the second drive pulley connected to the second ladder pulley such that rotation of the second drive pulley in the first rotational direction drives rotation of the second ladder pulley and rotation of the second drive pulley in the second rotational direction drives rotation of the second ladder pulley, the second lift cord being routed to pass between the second drive pulley and the second friction pulley such that the second lift cord passes along the second friction pulley and the second drive pulley without being entrained by the second ladder pulley;
a second ladder supporting the slats, the second ladder connected to the second ladder pulley of the second ladder control mechanism;
the first lift cord extending along the first drive pulley of the first ladder control mechanism such that motion of the first lift cord along the first drive pulley during extension of the slats drives rotation of the first drive pulley in the first rotational direction to rotate the first ladder pulley for tilting of the slats from an open position to a closed position and motion of the first lift cord along the first drive pulley during retraction of the slats drives rotation of the first drive pulley in the second rotational direction to rotate the first ladder pulley for tilting of the slats from the closed position to the open position; and
the second lift cord extending along the second drive pulley of the second ladder control mechanism such that motion of the second lift cord along the second drive pulley during extension of the slats drives rotation of the second drive pulley in the second rotational direction to rotate the second ladder pulley for tilting of the slats from an open position to a closed position and motion of the second lift cord along the second drive pulley during retraction of the slats drives rotation of the second drive pulley in the first rotational direction to rotate the second ladder pulley for tilting of the slats from the closed position to the open position.

20. The venetian blind of claim 19, wherein:
the first ladder comprises a first front rail, a first rear rail and spaced apart first rungs extending between the first front rail and the first rear rail, the first front rail and the first rear rails being segments of a cord or tape that is looped about the first ladder pulley;
wherein the second ladder comprises a second front rail, a second rear rail and spaced apart second rungs extending between the second front rail and the second rear rail, the second front rail and the second rear rails being segments of a cord or tape that is looped about the second ladder pulley;
the spring motor unit comprises:
a first spring motor pulley;
a second spring motor pulley; and
a spring member extending between the first and second spring motor pulleys;
the first ladder control mechanism also comprises:
a first housing, the first drive pulley and the first ladder pulley connected to the first housing such that a rotational axis about which the first drive pulley is rotatable is perpendicular to a rotational axis about which the first ladder pulley is rotatable, the first drive pulley being located below the first ladder pulley, and
a first gear connected to the first drive pulley and a second gear connected to the first ladder pulley, the first gear having teeth that intermesh with teeth of the second gear such that rotation of the first drive pulley drives rotation of the first ladder pulley;
the second ladder control mechanism also comprises:
a second housing, the second drive pulley and the second ladder pulley connected to the second housing such that a rotational axis about which the second drive pulley is rotatable is perpendicular to a rotational axis about which the second ladder pulley is rotatable, the second drive pulley being located below the second ladder pulley, and
a first gear connected to the second drive pulley and a second gear connected to the second ladder pulley, the first gear of the second ladder control mechanism having teeth that intermesh with teeth of the second gear of the second ladder control mechanism such that rotation of the second drive pulley drives rotation of the second ladder pulley;
the venetian blind also comprises:
a first lift cord pulley connected to the first spring motor pulley, the first lift cord connected to the first lift cord pulley to be connected to the spring motor unit, the first lift cord being windable about the first lift cord pulley during retraction of the slats and the first lift cord being unwindable form the first lift cord pulley during extension of the slats; and
a second lift cord pulley connected to the second spring motor pulley, the second lift cord connected to the second lift cord pulley to be connected to the spring motor unit, the second lift cord being windable about the second lift cord pulley during retraction of the slats and the second lift cord being unwindable form the second lift cord pulley during extension of the slats; and
wherein the first lift cord is routed between the first drive pulley and the first friction pulley such that the first lift cord extends horizontally between the first friction pulley and the first drive pulley or forms a first loop between the first drive pulley and the first friction pulley and the second lift cord is routed between the second drive pulley and the second friction pulley such that the second lift cord extends horizontally between the second friction pulley and the second drive pulley or forms a second loop between the second drive pulley and the second friction pulley.
